(19) United States
(12) Patent Application Publication
(10) Pub. No.: US 2003/0012089 A1
(43) Pub. Date: Jan. 16, 2003

(54) Disk playing apparatus

(76) Inventor: Fumihiko Fujimoto, Kobe-shi (JP)

Correspondence Address: CHRISTIE, PARKER & HALE, LLP, 350 WEST COLORADO BOULEVARD, SUITE 500, PASADENA, CA, 91105, US

(21) Appl. No.: 10/176,241

(22) Filed: Jun. 19, 2002

(30) Foreign Application Priority Data
Jun. 21, 2001 (JP) 2001-188559

(51) Int. Cl. G11B 7/085; G11B 21/08

(52) U.S. Cl. 369/30.82; 369/30.78

(57) ABSTRACT

A disk autochanger having good operability is provided while implementing miniaturization of an apparatus. First holding means that can contain a plurality of disks and second holding means that can contain a plurality of disks are provided, wherein a disk is transferred between said first holding means and said second holding means so that necessary space can be reserved above or below the disk to be played to allow said disk playing means to play the disk. Therefore, a new disk can be inserted even while the other disk is being played, resulting in an improvement in operability. Further, the apparatus can be miniaturized by configuring the disk autochanger so that the disks contained in the first holding means, the disks contained in the second holding means, and the disk that is being played are overlapped, at least partially, on a projected area.

### BACKGROUND OF THE INVENTION

1. Field of the Invention

The present invention relates to a disk playing apparatus that contains a plurality of disks such as CDs, MDs and the like and selects and plays a desired disk from the plurality of disks. It is to be noted here that the term “play” is used to mean both “play” and “record” in the context of the present invention.

2. Description of the Related Art

A conventional disk playing apparatus will be described with reference to FIG. 1. FIG. 1 is a side view that shows an internal construction of the disk playing apparatus schematically to facilitate understanding of the functions of each component.

A disk playing apparatus 10 as shown in FIG. 1 comprises a holding member 41 for containing a plurality of disks 1, and a playing unit 6 for playing a signal recorded on the disk 1. The disk 1 is played in the playing unit 6 in a position wherein a portion of the played disk 1 is overlapped with other disks 1 stored in the holding member 41 in the direction of the stacked disks.

The holding member 41 is comprised of a plurality of stockers 42. Each stocker can be separated and movable in the direction of the stacked disks 1. The playing unit 6 can be movable between the playing position (A) and the standby position (B). While playing, a shutter 8 closes an opening 7. When the disk 1 is inserted from the opening 7 during standby, the disk 1 is conveyed onto the holding member 41 by the playing unit 6.

In the disk playing apparatus 10 shown in the figure, as the disk 1 is played in a position in which a portion of the played disk 1 is overlapped with other disks 1 stored in the holding member 2 in the direction of the stacked disks, the size of the apparatus can be reduced.

Though the above disk playing apparatus has an advantage in that the apparatus can be miniaturized, it has a problem in that the disk can be neither inserted nor removed while playing another disk, since stockers 42 that are separated and located below the playing unit 6 cannot be aligned with the opening 7. Therefore, while a disk is played or recorded, if a user wishes to insert or remove another disk, the user must perform manipulation to stop playing or recording and wait till the apparatus is in a state wherein the disk can be inserted, which may result in poor operability.

### SUMMARY OF THE INVENTION

It is an object of the present invention to obtain a disk playing apparatus having good operability while implementing miniaturization of the apparatus.

The present invention is intended to achieve the above object. A disk playing apparatus of the present invention comprises first holding means that can contain a plurality of disks, second holding means that can contain a plurality of disks, disk playing means for playing a disk, and disk transfer means for transferring the disk between said first holding means and said second holding means so that necessary space can be reserved above or below the disk to be played to allow said disk playing means to play the disk.

According to the present invention, the operability can be improved by efficiently utilizing space that has been necessary to allow the holding member to move in the prior art disk playing apparatus.

In the present invention, the disk playing apparatus can be miniaturized by configuring the disk playing apparatus so that one disk contained in the first holding means and the other disks contained in the second holding means are overlapped at least partially in the direction of the stacked disks or a disk contained in at least one of the first holding means and the second holding means and another disk that is played are overlapped at least partially in the direction of the stacked disks during a playing operation while the another disk is played by the disk playing means.

Further, operability of the disk playing apparatus can be improved by providing an opening for inserting the disk in proximity to the first holding means that allows a disk inserted from outside to be housed in the first holding means.

### BRIEF DESCRIPTION OF THE DRAWINGS

The above object and features of the present invention will be more apparent from the following description of the preferred embodiment with reference to the accompanying drawings, wherein:

FIG. 1 is a side view showing a configuration of a conventional disk autochanger;

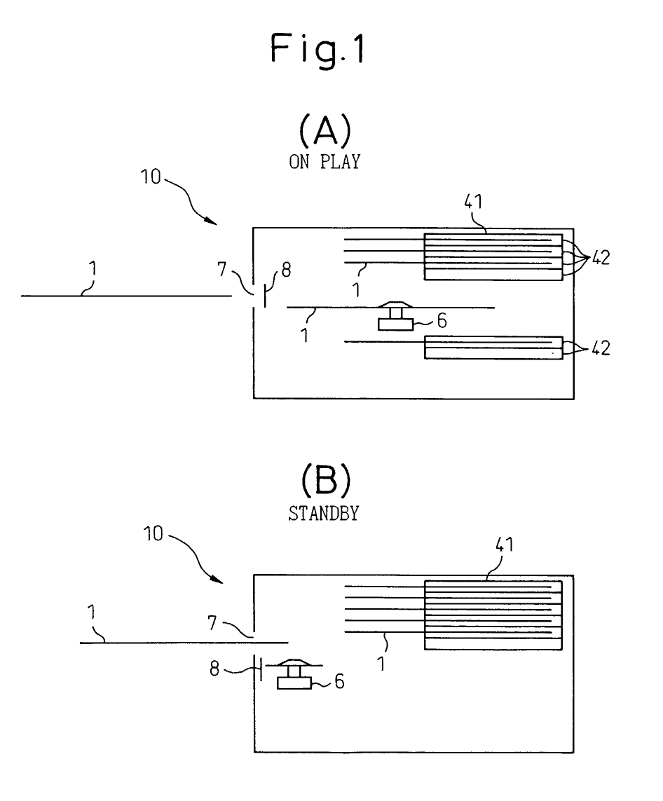

FIG. 2 is a side view showing a configuration of a disk autochanger according to an embodiment of the present invention;

FIG. 3 is a perspective view showing a construction of a first disk holding member and a second disk holding member shown in FIG. 2;

FIG. 4 is a top view showing a construction of the first holding member and the second holding member shown in FIG. 2;

FIG. 5 is a drawing describing movement of a playing and recording unit shown in FIG. 4;

FIG. 6 is an exploded perspective view of a moving mechanism of the first disk holding member shown in FIG. 2;

FIG. 7 is a perspective view showing a first elevating and descending mechanism of the moving mechanism shown in FIG. 6 in an assembled state;

FIG. 8 is a perspective view showing a second elevating and descending mechanism of the moving mechanism shown in FIG. 6 in an assembled state;

FIG. 9 is a perspective view of a shutter driving mechanism shown in FIG. 2 in a closed state;

FIG. 10 is a perspective view showing the shutter driving mechanism shown in FIG. 2 in an open state;

FIG. 11 is a diagram describing the the operation of the disk autochanger shown in FIG. 2 (automatic changing operation 1);

FIG. 12 is a diagram describing the operation of the disk autochanger shown in FIG. 2 (automatic changing operation 2);

FIG. 13 is a diagram describing the operation of the disk autochanger shown in FIG. 2 (automatic changing operation 3);

FIG. 14 is a diagram describing the operation of the disk autochanger shown in FIG. 2 (automatic changing operation 4);

FIG. 15 is a diagram describing the operation of the disk autochanger shown in FIG. 2 (disk ejecting operation 1);

FIG. 16 is a diagram describing the operation of the disk autochanger shown in FIG. 2 (disk ejecting operation 2);

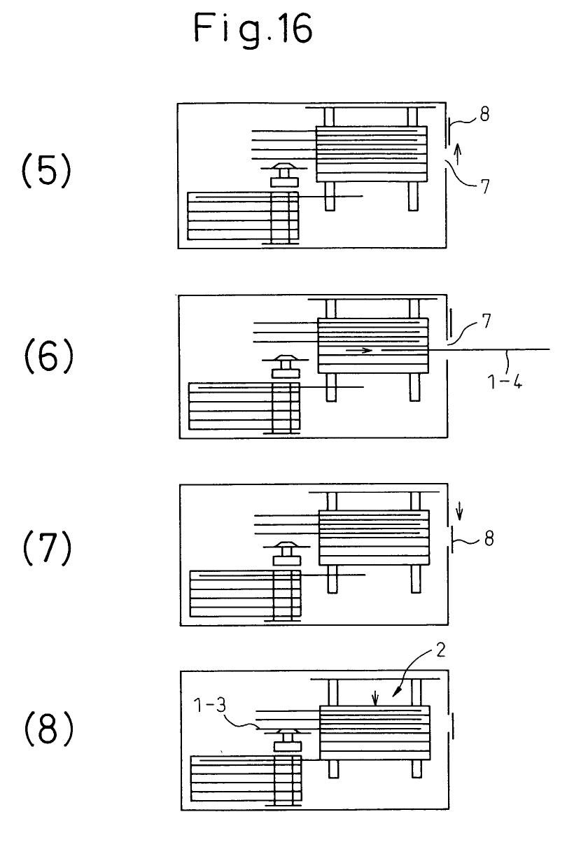

FIG. 17 is a diagram describing the operation of the disk autochanger shown in FIG. 2 (disk ejecting operation 3);

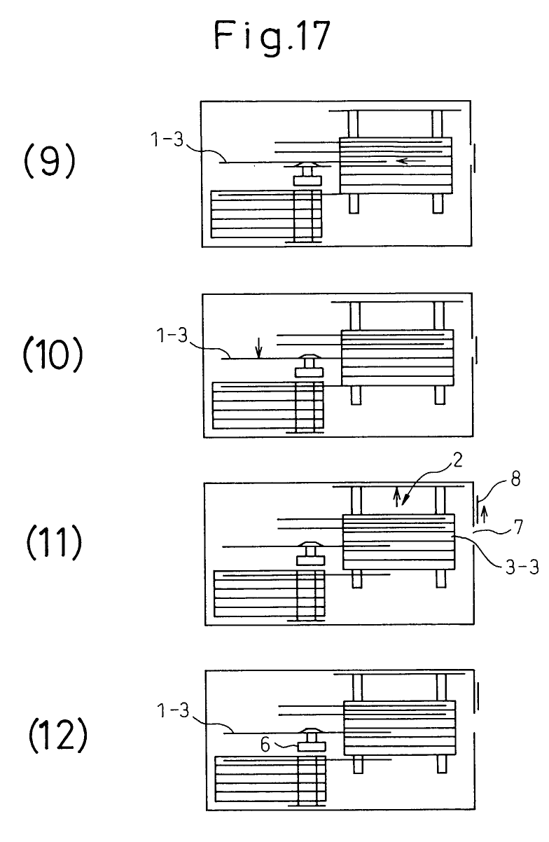

FIG. 18 is a diagram describing the operation of the disk autochanger shown in FIG. 2 (disk inserting operation);

FIG. 19 is a diagram describing the operation of the disk autochanger shown in FIG. 2 (correlation management between disk numbers and stocker numbers 1);

FIG. 20 is a diagram describing the operation of the disk autochanger shown in FIG. 2 (correlation management between disk numbers and stocker numbers 2);

FIG. 21 is a diagram describing the operation of the disk autochanger shown in FIG. 2 (correlation management between disk numbers and stocker numbers 3);

FIG. 22 is a diagram describing the operation of the disk autochanger shown in FIG. 2 (correlation management between disk numbers and stocker numbers 4); and

FIG. 23 is a flow chart describing the operation of the disk autochanger shown in FIG. 2.

### DESCRIPTION OF THE PREFERRED EMBODIMENTS

An embodiment of the present invention will be described with reference to the drawings.

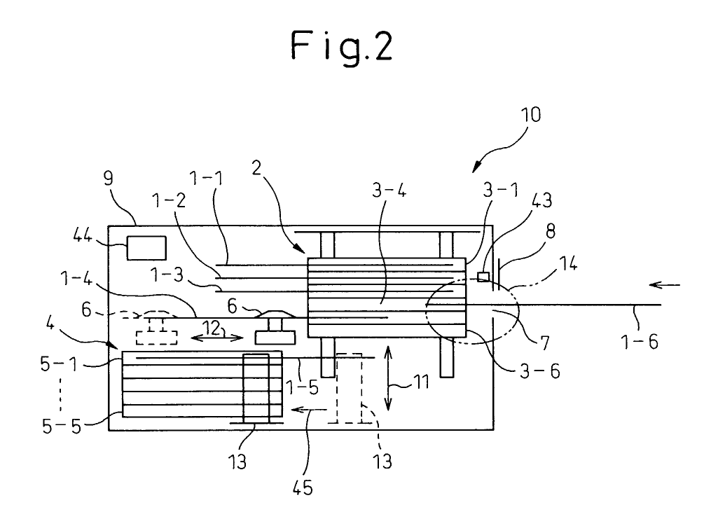

FIG. 2 is a side view that shows an internal construction of the disk autochanger 10, schematically, to facilitate understanding of the functions of each component.

An opening 7 is provided on the front side of a main body 9 of the apparatus for inserting and ejecting a disk 1. The opening 7 is equipped with a shutter 8 for opening and closing the opening. A disk detector 43 is disposed in proximity to the shutter 8. A controlling unit 44 that is comprised of a microprocessor is disposed at the top of the innermost side of the apparatus.

A first disk holding member 2 is disposed at the side of the opening 7. As indicated by an arrow 11, the first disk holding member 2 can be movable in the direction of stacked disks. The first disk holding member 2 has a number of stockers (six stockers in the example shown in the figure) 3-1-3-6 that can be contained in the apparatus.

A second disk holding member 4 is disposed at the innermost side of the main body 9 of the apparatus. The second disk holding member 4 is secured to the apparatus. The second disk holding member 4 has stockers (five stockers in the example shown in the figure) the number of which is one less than the number of the stockers in the first disk holding member.

A playing and recording unit 6 is disposed on the second disk holding member 4 adjacent to the side of the second disk holding member 2. The playing and recording unit 6 can be moved between a position wherein a disk is played or recorded (shown by solid lines) and a withdrawn position (shown by broken lines) as indicated by an arrow 12. In the following description, an example wherein a playing operation is performed by the playing and recording unit 6 will be described, but it is to be noted that recording operation can also be performed in a similar manner.

A transfer mechanism 13 is disposed at the bottom of the main body 9 of the apparatus for transferring the disk 1 between the first disk holding member 2 and the second disk holding member 4. The transfer mechanism 13 can be movable between the second disk holding member 4 and the first disk holding member 2 as indicated by an arrow 45.

The disk 1 which is inserted through the opening 7 is transferred by the inserting and ejecting mechanism 14 and held by the first disk holding member 2.

In a state shown in FIG. 2, three disks 1-1-1-3 are held in the first disk holding member 2, a disk 1-4 is being played by the playing and recording unit 6, and a disk 1-5 is held by the second disk holding member 4. In this state, when a disk 1-6 is inserted through the opening 7, the disk 1-6 is held in an empty stocker 3-4 of the first disk holding member 2.

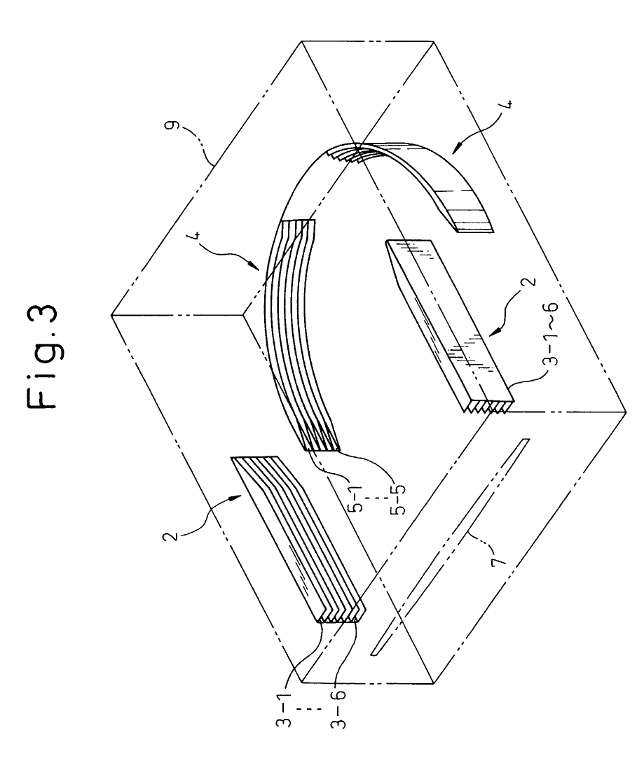

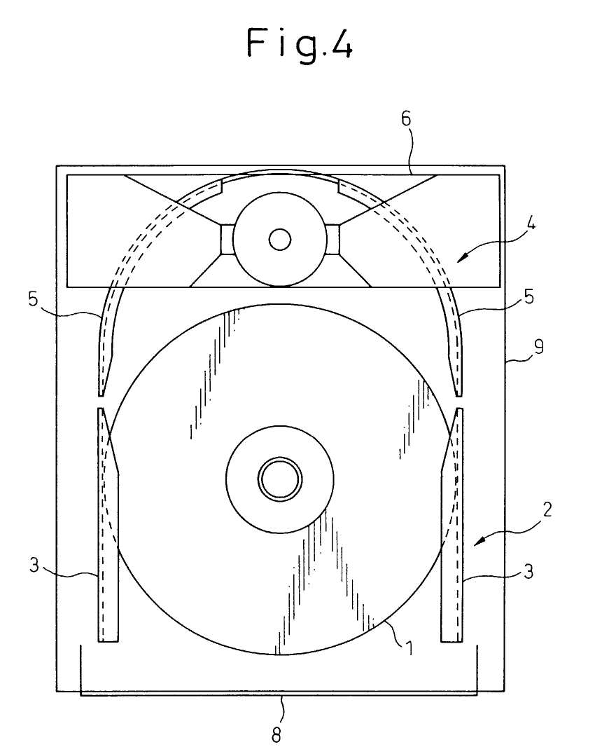

Referring to FIG. 3 and 4, a structure of the first disk holding member 2 and of the second disk holding member 4 will be described. FIG. 3 is a perspective view showing relationship between the first disk holding member 2 and the second disk holding member 4 and FIG. 4 is a top view. Here, it is to be noted that FIG. 4 shows a state wherein the disk 1 is held in the first disk holding member 2. Further, it is to be noted that the playing and recording unit 6 is shown in FIG. 4 to facilitate the description provided below.

As shown in FIG. 3, the first disk holding member 2 is comprised of 6 stockers 3-1-3-6 that are formed integrally. Each stocker 3-1-3-6 is comprised of a slot formed in the direction of disk movement to move the disk 1 between the opening 7 and the second disk holding member 4.

The second disk holding member 4 is comprised of 5 stockers 5-1-5-5 that are formed integrally. Each stocker 5-1-5-5 is comprised of a semicircular slot for holding the disk 1 that is transferred from the first disk holding member 4.

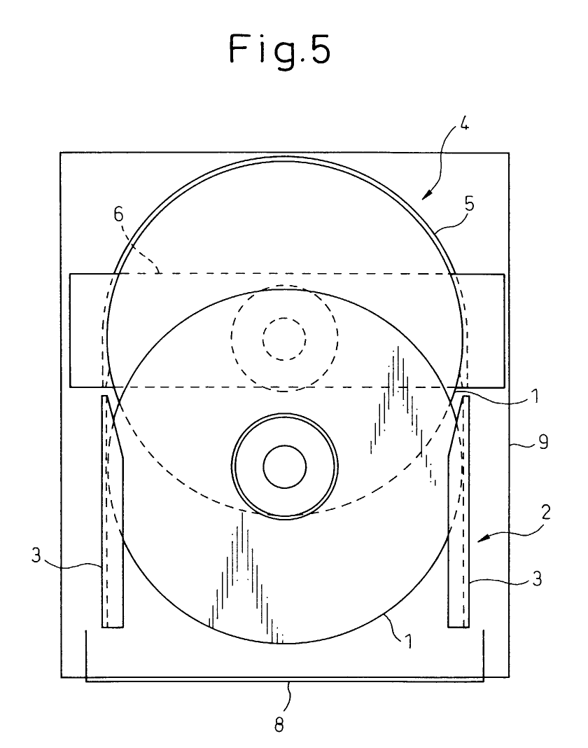

Referring to FIG. 4 and 5, movement of the playing and recording unit 6 will be described.

FIG. 4 shows a state wherein the playing and recording unit 6 is withdrawn at the innermost side of the main body 9 of the apparatus, while FIG. 5 shows a state wherein the playing and recording unit 6 is moved to a position to play the disk 1.

As shown in FIG. 5, the central axis of the disk 1 that is being played coincides with the central axis of the disk 1 that is held in the second disk holding member 4. Even in such configuration, the disk 1 that is being played never comes into contact with the first disk holding member 2. Therefore, such a configuration allows the apparatus to be miniaturized.

As shown in FIG. 4, the playing and recording unit 6 is configured so that it is not overlapped with a projected area of the disks 1 held in the first disk holding member 2. Therefore, when the playing and recording unit 6 is withdrawn into the withdrawn position, the first disk holding member 2 can be moved in the direction of the stacked disks while holding the disk 1, without interference between the playing and recording unit 6.

As evident from FIG. 5, the center line of the disks 1-1-1-3 held in the first disk holding member 2 is offset to the center line of the disk 1-5 held in the second disk holding member 4. Further, an outer configuration of each of the holding members 2, 4 is designed so that one of the holding members is not overlapped with the other of the holding members in the direction of the stacked disks. Such a configuration allows the first disk holding member 2 and the second disk holding member 4 to be disposed adjacent to each other and therefore allows the apparatus to be miniaturized.

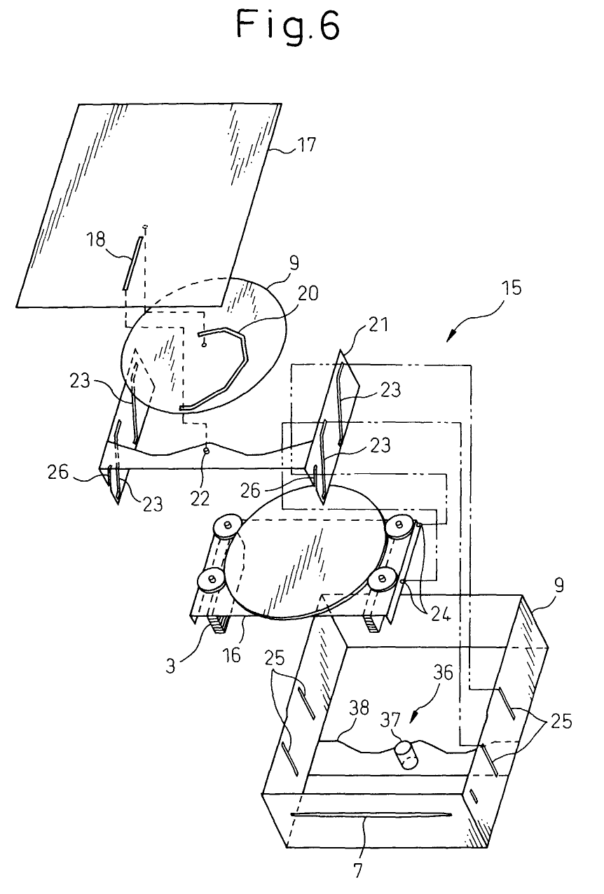

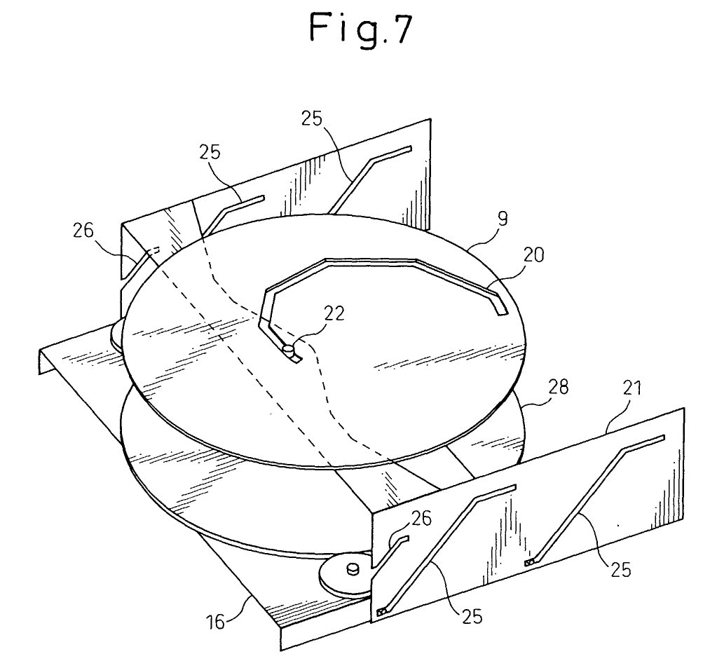

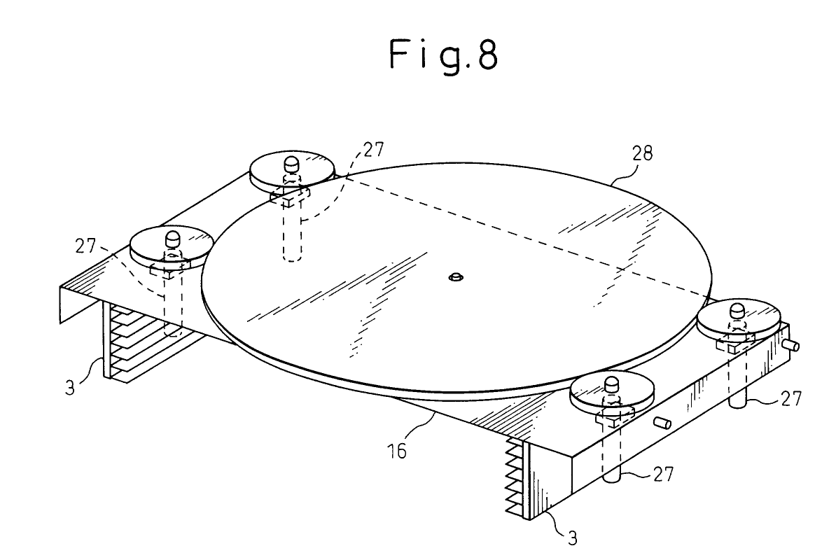

Referring to FIG. 6, 7 and 8, a moving mechanism of the first disk holding member 2 will be described. FIG. 6 is an exploded view showing the moving mechanism of the first disk holding member 2. FIG. 7 shows a first elevating and descending mechanism of the moving mechanism in an assembled state. FIG. 8 shows a second elevating and descending mechanism of the moving mechanism in an assembled state.

The moving mechanism 15 is comprised of the first elevating and descending mechanism for moving a base 16 of the first disk holding member 2 from a position that is nearest to the second disk holding member 4 to a position that is farthest from the second disk holding member 4 by a larger distance, and the second elevating and descending mechanism for moving the stocker 3 against the base 16 by a smaller distance in a range of stacked disks the number of which is one less than the maximum number that can be accommodated in the apparatus.

A linear slit 18 is formed in the forward/backward direction on a top plate 17 (a fixed portion) of the main body 9 of the apparatus. A driving cam 19 of the first elevating and descending mechanism is attached to the top plate 17 rotatably. On the cam 19, a curved slit 20 is formed. A pin 22 that is provided at the upper central part of a driving lever 21 of the first elevating and descending mechanism is engaged with the slits 18, 20. When the driving cam 19 is driven by a mechanism that is not shown and rotated, the driving lever 21 is moved between the frontward side (the side of the opening 7) and the innermost side in the forward/backward direction by means of engagement of the pin 22 with the slits 18, 20.

On the side of the driving lever 21, a total of four slits 23, two each for the left and right sides, are formed wherein each slit has horizontal top and bottom ends and an slanted intermediate part. In turn, on the side of the base 16 of the first disk holding member 2, a total of four pins 24, two each for the left and right sides, are provided. Further, on the side (a fixed portion) of the main body 9 of the apparatus, a total of four slits 25 in a longitudinal direction, two each for the left and right sides, are formed. Each of the pins 24 is engaged with the slits 23, 25. When the driving lever 21 is moved in the forward/backward direction, the base 16 is moved up and down by means of engagement of the pins 24 with the slits 23, 25. Consequently, the first disk holding member 2 is moved between the upper limit position and the lower limit position over a larger distance.

As the driving lever 21 is moved in the frontward direction, the pins 24 enter in the horizontal part of the slits 25, and then the up and down movement of the base 16 is stopped. Moreover, as the driving lever is moved further in the frontward direction, slanted slits 26 that are formed at the edge of the driving lever 21 are engaged with the shutter mechanism to open the shutter. The opening and closing operation of the shutter mechanism will be discussed later in detail, but here it is to be noted that the construction can be simplified by sharing one mechanism for both the driving mechanism of the first disk holding member 2 and the driving mechanism of the shutter 8.

In the second elevating and descending mechanism, as shown in FIG. 8, the stockers 3 are attached to the base 16 by four feed screws 27. Driving idle gears 28 are rotatably attached to the base 16 to drive each of the feed screws 27. When the driving idle gears 28 are driven by driving means that are not shown, the stockers 3 are moved up and down by means of rotation of the feed screws. The moving distance by the second elevating and descending mechanism is defined by a range of stacked disks the number of which is one less than the maximum number that can be accommodated in the apparatus (in other words, that can be held in the first disk holding member 2, five disks are shown in this example).

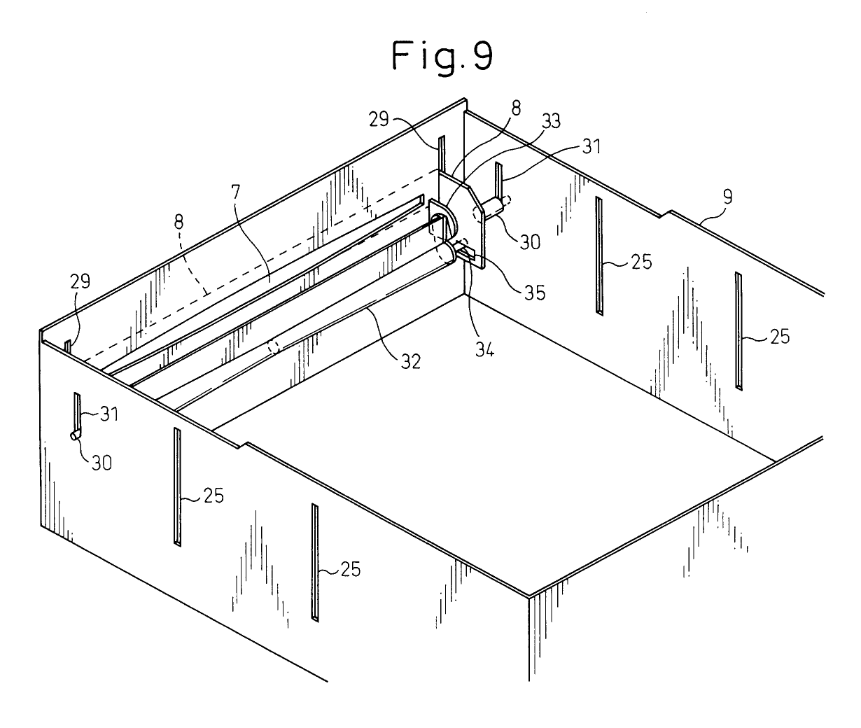

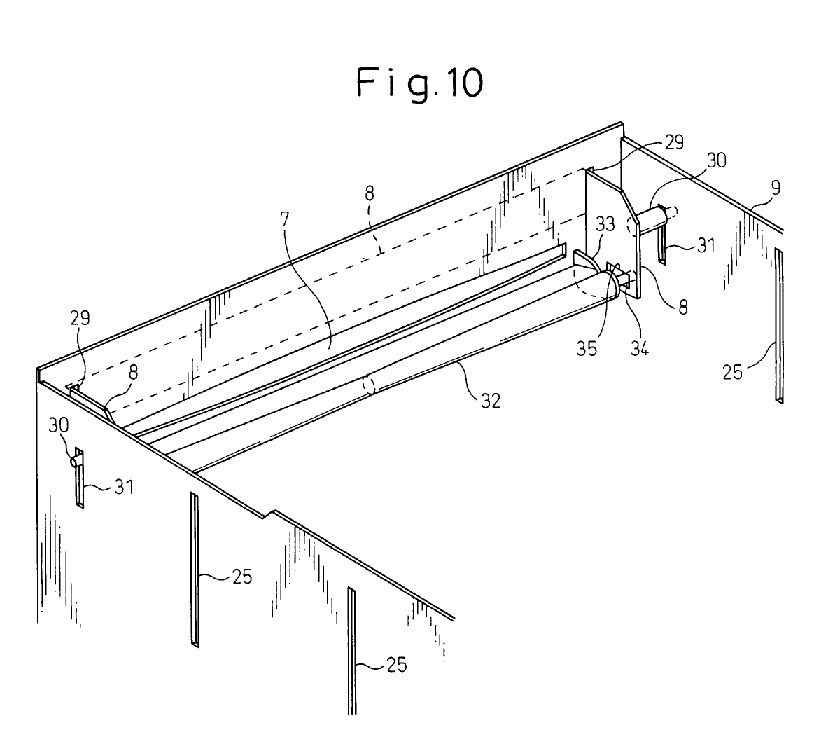

Referring to FIG. 9 and 10, an opening and closing mechanism of the shutter for opening and closing the opening 7 will be described. FIG. 9 shows the shutter in a closed state, and FIG. 10 shows the shutter in an open state.

On both sides of opening 7 at the front of the main body 9 of the apparatus, slits 29 in a vertical direction are formed. Both ends of the shutter 8 that closes the front side of the opening 7 are bent and protruded through the slits 29. In the apparatus, driving shafts 30 are attached to both ends of the shutter 8. Slits 31 in a vertical direction are formed on the sides of the main body 9 of the apparatus and, on the other hand, slanted slits 26 are formed at the edge of the driving lever 21.

When the driving levers 21 are driven to the front side of the main body 9 of the apparatus and the first disk holding member 2 is located at the upper limit position, if the driving levers 21 are further driven, the driving shafts 30 are moved to the upper position as shown in FIG. 10 by means of engagement with slits 26, 31. This allows the shutter 8 to open the opening 7. Conversely, if the driving levers 21 are driven to the innermost side of the main body 9 of the apparatus, the driving shafts 30 is moved to the lower side as shown in FIG. 9 by means of engagement with slits 26, 31. This allows the shutter 8 to close the opening 7. Here, it is to be noted that the base 16 is not moved up and down during such operation, since the pins 24 (FIG. 6) of the base 16 are engaged with the horizontal part of the slits 23.

A roller 32 is driven and interlocked with the shutter 8. The roller 32 holds the disk 1 from below between the opening 7 and the first disk holding member 2 when the disk is inserted or ejected. A roller holding member 33 is rotatably held at the front inner side of the main body 9 of the apparatus at the both sides of the opening 7. The roller 32 is rotatably held by the roller holding member 33. Roller shafts 34 are formed at both ends of the roller 32. The roller shafts 34 are engaged with horizontal slits 35 that are formed at both bent ends of the shutter 8. Therefore, when the shutter 8 is closed, the roller 32 is withdrawn in the downward direction and, on the other hand, when the shutter is opened, the roller 32 is moved in the upward direction to allow the disk 1 to be driven.

As described above, the construction can be simplified by driving the shutter 8 and the roller 32 by means of movement of the first disk holding member 2.

Here, it is to be noted that the inserting and ejecting mechanism 14 for moving the disk 1 between the first disk holding member 2 and the opening 7, and the driving member for moving the disk between the first disk holding member 2 and the playing and recording unit 6 are well known in the art and therefore a description of these components is omitted.

A transfer mechanism 36 for moving the disk 1 between the first disk holding member 2 and the second disk holding member 4 is shown in FIG. 6.

The transfer mechanism 36 is comprised of a pillar-like engaging unit 37 and a mounting member 38 for mounting the engaging unit. The engaging unit 37 has a diameter that can be inserted in a center hole of the disk 1 and a height that can be engaged with all disks that are contained in the second disk holding member 4. The transfer mechanism 36 is moved by means of the driving mechanism which is not shown and stops at the position of the center line of the disk that is held in the first disk holding member 2 and also at the position of the center line of the disk that is held in the second disk holding member 4.

Next, entire operation of the disk autochanger discussed above will be described. The following operation is executed by the controlling unit 44 based upon the user's manipulation.

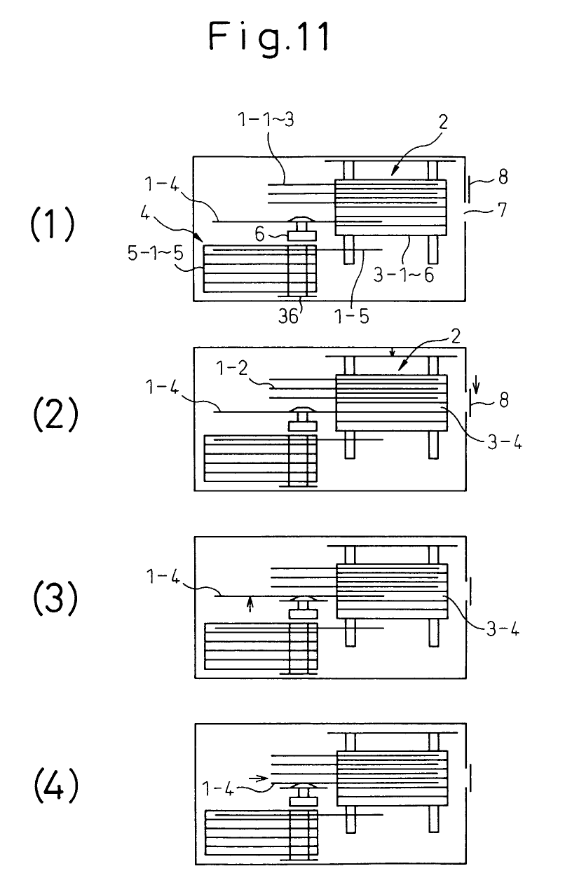

Referring to FIG. 11, 12, 13 and 14, an operation for changing the played disk automatically will be described. In the following example, a case when a disk that has been inserted in second is played after playing a disk that has been inserted in fourth is described.

(1) shows a state wherein five disks 1-1-1-5 are contained in the apparatus. In this case, the disks 1-1-1-3 that have been inserted in first, second and third are held in the stockers 3-1-3-3 at the upper side, the disk 1-4 that has been inserted in fourth is played, and the disk 1-5 that has been inserted in fifth is held in the uppermost part of the second disk holding member 4. The first disk holding member 2 is located at the upper limit position by means of the first elevating and descending mechanism, wherein the stocker 3-4 (in an empty state) that is the fourth from the above is in the position opposite to the opening 7.

Further, the shutter 8 is in the open state. Here, if a new disk 1-6 is inserted from the opening 7, it can be contained in the first disk holding member 2 even while the other disk is played.

The engaging unit 37 of the transfer mechanism 36 is engaged with the center hole of the disk 1-5 that is held in the second disk holding member 4.

When the playing is finished, the shutter 8 is closed as shown in (2). Then, the second disk 1-2 is prepared to be played. In (3), the first disk holding member 2 is moved by means of the second elevating and descending mechanism so that the disk 1-4 that has been played is contained in the stocker 3-4 that is the fourth stocker from above (the stocker located in the highest position among the empty stockers 3) and the clamp is released. During such movement, the stocker 3 does not make contact with the disk 1. Then, in (4), the disk 1-4 that has been played is contained.

In (5), the playing and recording unit 6 is withdrawn. In (6), the first disk holding member 2 descends from the upper limit position to the lower limit position by means of the first elevating and descending mechanism. At the same time, the disk 1-5 that has been held by the second disk holding member 4 (the disk that has been in the uppermost position) is moved by means of the second elevating and descending mechanism to the position opposite to the fifth stocker 3-5 in the first disk holding member 2 (the stocker at the uppermost position among the empty stockers). During this operation, the playing and recording unit 6 never makes contact with the disk 1, since it is in the withdrawn position.

In (7), by means of movement of the transfer mechanism 36, the disk 1-5 is held in the stocker 3-5 of the first disk holding member 2. In (8), the first disk holding member 2 descends so that the third and further disks 1-3-1-5 in the position lower than the second disk that is to be played are located in the position opposite to the stockers 3-1-3-3 at the upper position of the second disk holding member 4.

In (9), the transfer mechanism 36 is moved so that the disks 1-3-1-3 are held in the second disk holding member 4. In (10), the first disk holding member 2 is moved by means of the first elevating and descending mechanism so that the second disk 1-2 is in the playing position. In (11), the playing and recording unit 6 is moved to the playing position.

In (12), the disk 1-2 is driven to the playing position, and then in (13), the disk is clamped. In (14), the first holding member 2 is moved to the upper limit position by means of the first elevating and descending mechanism, the second stocker 3-2 (the stocker at the uppermost position among the empty stockers) is moved to the position opposite to the opening 7, and at the same time, the shutter 8 is opened. In (15), the second disk 1-2 is played. While it is played, if a new disk is inserted through the opening 7, it can be contained in the stocker 3-2.

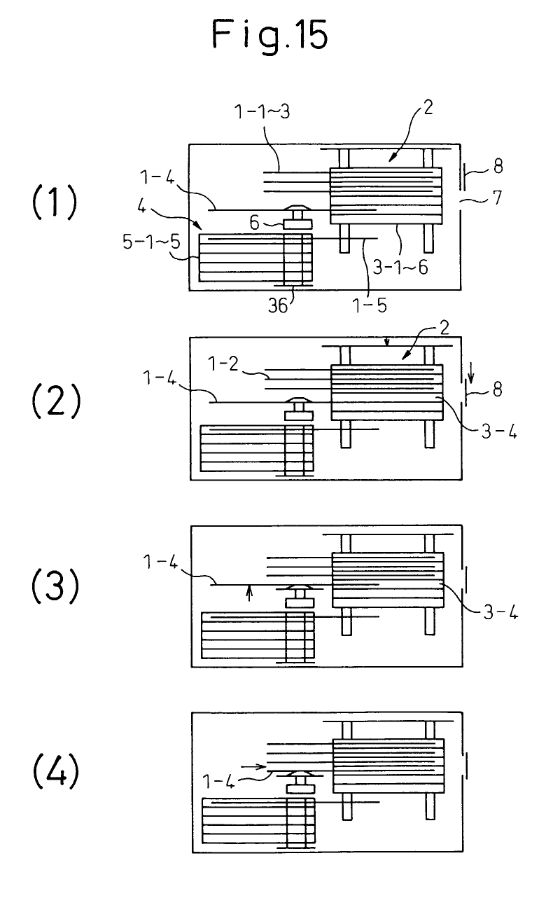

Referring to FIG. 15, 16 and 17, the operation for ejecting the disk will be described.

In the following example, a case when the disk that has been inserted in fourth is ejected after the playback, and then the disk that has been inserted in third is played, is described.

Steps (1)-(4) are similar to the ones in FIG. 11 described above. More specifically, the disk 1-4 is played in (1), the shutter 8 is closed in (2), the clamp is released in (3), and in (4), the disk 1-4 is contained in the stocker 3-4 that is the fourth stocker from above in the first disk holding member 2.

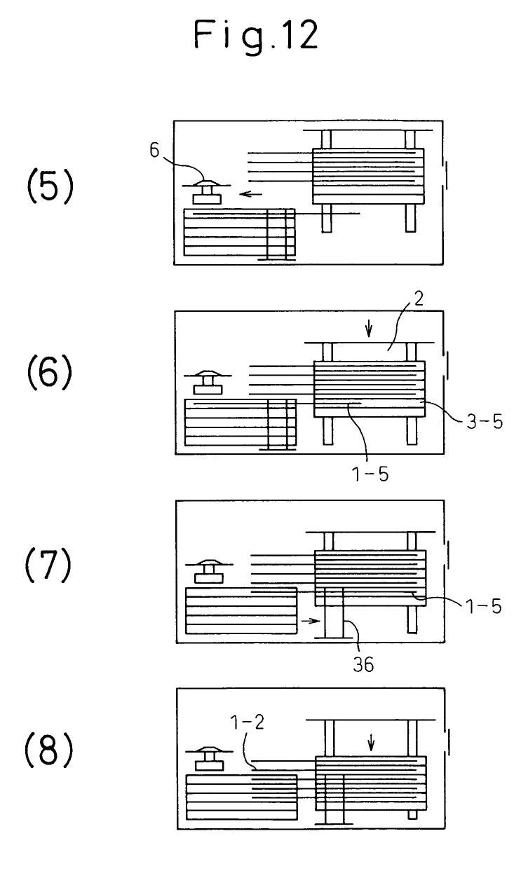

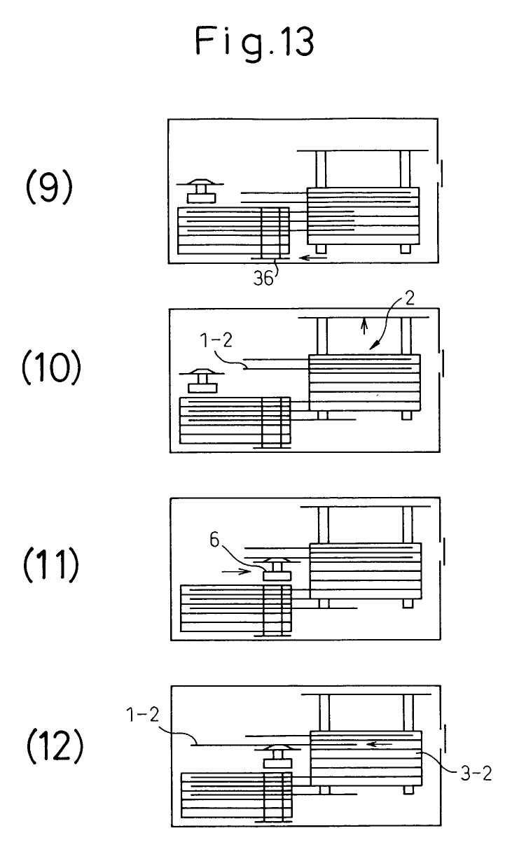

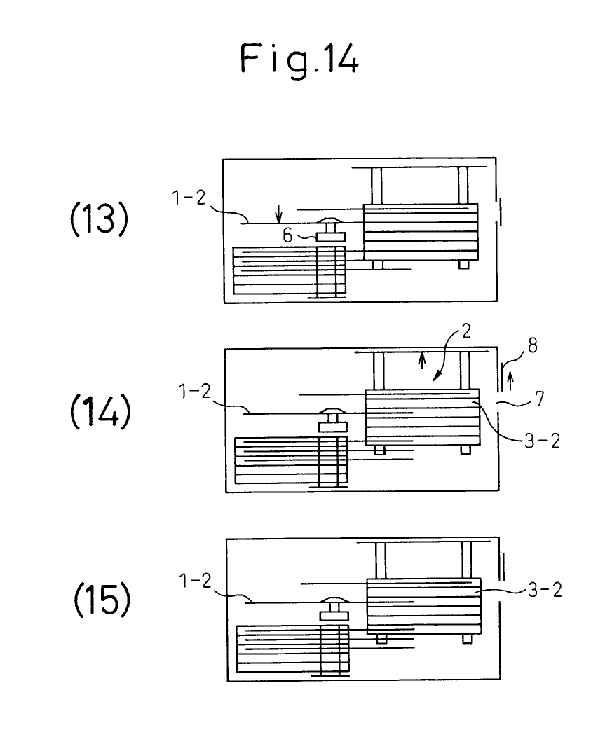

In (5), the shutter 8 is elevated and the opening 7 is opened. In (6), the disk 1-4 is ejected through the opening 7. In (7), the shutter 8 is closed. Then, in (8), the disk 1 is selected by the second elevating and descending mechanism. Since it is assumed in this example that the third disk 1-3 is selected, the first disk holding member 2 descends so that the third stocker 3-3 is located in the playing position. If the other disk is selected, the disk transfer operation is performed between the first disk holding member 2 and the second disk holding member 4 as shown in FIG. 11-14, described above.

After the disk 1-3 is selected, the disk 1-3 is drawn out to the position of the playing and recording unit 6. In (10), the disk 1-3 is clamped. In (11), when the first holding member 2 is moved to the upper limit position by means of the second elevating and descending mechanism, the empty third stocker 3-3 is moved to the position opposite to the opening 7 and at the same time, the shutter 8 is opened. In (12), the disk 1-3 is played by the playing and recording unit 6. The operation described above allows the disk inserted from the opening 7 to be contained in the stocker 3-3 even while the other disk is played.

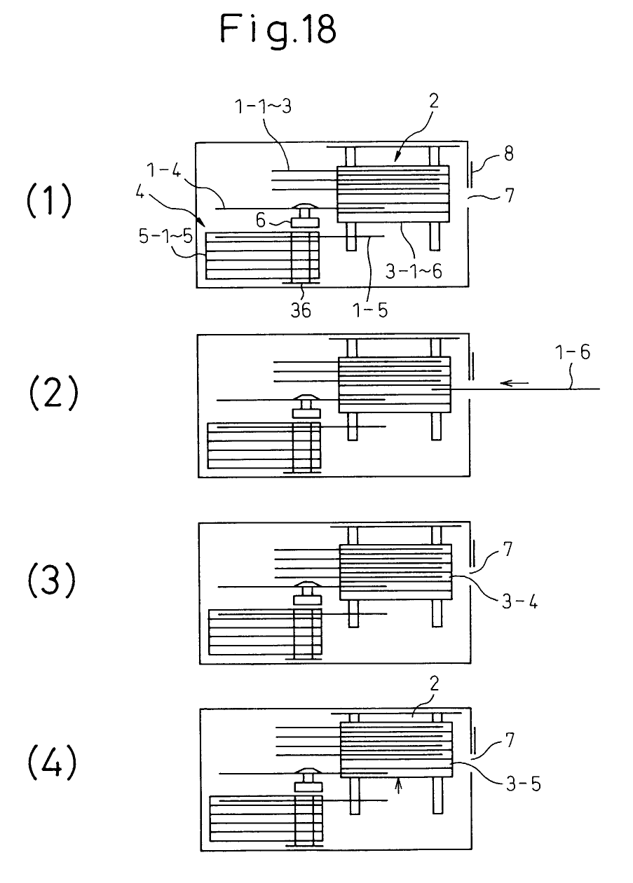

Referring to FIG. 18, operation when the disk is inserted will be described.

(1) shows a state similar to the case shown in FIG. 11 and 15, wherein the five disks 1-1-1-5 are contained in the apparatus and the disk 1-4 that has been inserted for the fourth time is played. When the sixth disk 1-6 is inserted from the opening 7 in (2), the disk 1-6 is moved to the fourth stocker 3-4 by means of the driving mechanism that is not shown and held in the fourth stocker in (3). Subsequently, in (4), the fifth stocker 3-5 (the uppermost stocker among the empty ones) is moved to the position that is opposite to the opening 7.

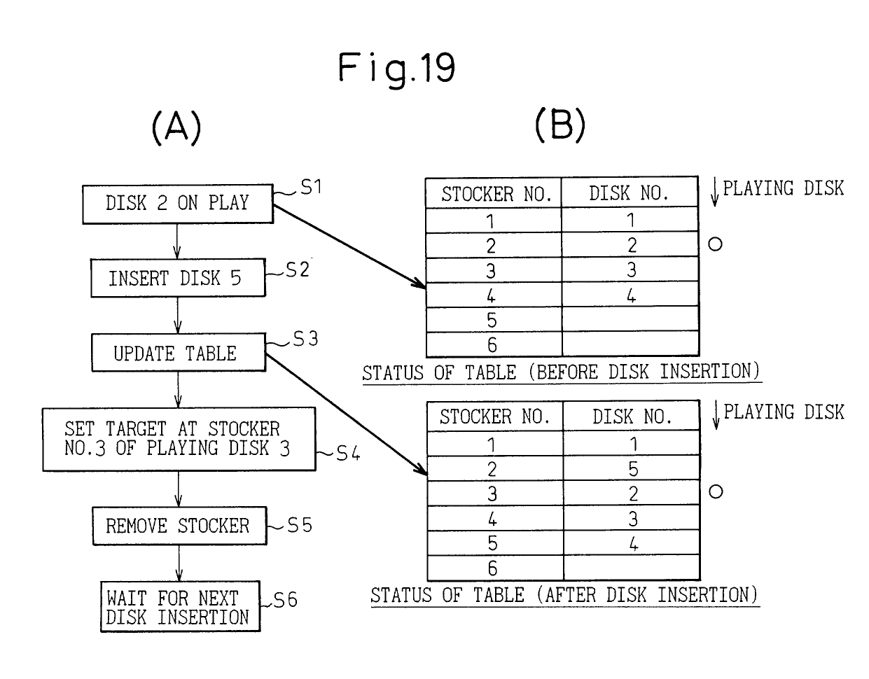

Referring to FIG. 19, 20 and 22, an operation for correlating the number between the disks 1 and the stockers 3, 5 will be described.

When the disks are inserted into the empty apparatus up to the maximum number that can be contained, the disks are held in the stocker in the order of insertion (according to the disk number). In this case, by managing the number of stockers 3-1-3-6, and 5-1-5-5, the controlling unit can provide management of the playing operation of the disks similar to the one according to the disk number. However, as is evident from the example described above, after the disks 1 are ejected and inserted repeatedly, the disk number may not coincide with the stocker number.

In the following example, when the disks 1 are played and inserted/ejected, the disk number management operation is performed by using a table that associates the disk number to the stocker number. In each of the drawings, (A) shows a procedure of the process, and (B) shows contents of the table. Further, it is to be noted that the disks and stockers are numbered simply 1-6.

Referring to FIG. 19, operation when the new disk is inserted while another disk is being played will be described.

In this example, six disks can be contained in the apparatus. The stockers are divided into the first desk holding member 2 and the second disk holding member 4 in the above described examples, but here, to simplify the description, all stockers are described as one unit collectively. Further, it is to be noted that the disks are numbered 1-6 in the order of insertion.

First, it is assumed that four disks 1-4 are contained in the apparatus and the disk 2 is played (Step S1). Here, it is to be noted that, in effect, the disk 1 is held in the first disk holding member 2 and the disks 3, 4 are held in the second disk holding member 4. The stocker 2 in which the disk 2, that is playing at present, had been held is in the position that is opposite to the opening.

When the fifth disk is inserted newly (Step S2), this disk is contained in the stocker 2. Then, the table is updated (Step S3) so that the stocker 2 corresponds to the disk 5, and the holding position of the disks 2-4 are pushed down to the stockers 3-5, respectively.

In this state, the disk that is inserted next should be contained in the stocker 3, which corresponds to the disk 2 that is played at present. Therefore, the stocker 3 that corresponds to the disk 2 is set as the target to contain the newly inserted disk (Step S4). Then, the target stocker 3 is moved to the position that is opposite to the opening 7 (Step S5) to wait for the insertion of the next disk (Step S6).

By using the table described above, an operation such as for playing the disks and the like can be managed according to the order of insertion of the disks by the user without any inconvenience.

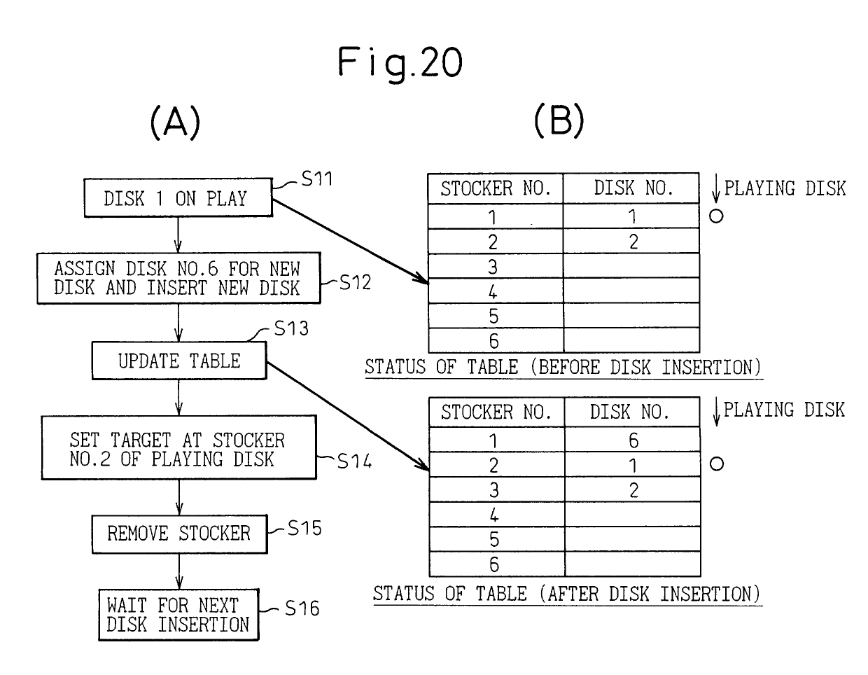

Referring to FIG. 20, the operation wherein the user specifies the disk number will be described.

This example shows a case wherein the user specifies a new disk as the disk 6 and inserts it into the apparatus when two disks 1, 2 are already contained in the apparatus.

The disk 1 is being played (Step S11). In such condition, the disk 2 is held in the second disk holding member 4, and the stocker 1 in which the disk 1 that is being played has been held is in the position opposite to the opening. The user manipulates the controlling unit (not shown) to specify a new disk as the disk 6 and insert it through the opening (Step S12). Then, the disk 6 is held in the stocker 1, and the table is updated so that the inserted disk 6 corresponds to the stocker 1, and the position of the disk 1, 2 is pushed down to correspond to the stocker 2, 3, respectively (Step S13).

In this state, with reference to the table, the disk 1, that is playing at present, is associated with the stocker 2. Therefore, also with reference to the table, the disk that is newly inserted through the opening 7 should be contained in the stocker 2 (the target of the operation), which, on the other hand, corresponds to the disk 1 (Step S14). Then, the targeted stocker 1 is moved to the position opposite to the opening 7 (Step S15) to wait for the insertion of the next disk (Step S16). After that, the user can specify the disk number 3-5 and insert the disks.

According to this example, as the user can specify the disk number irrespective of the order of insertion and the apparatus can manage the disks depending upon the disk number specified by the user in this case, the operability of the apparatus can be further improved.

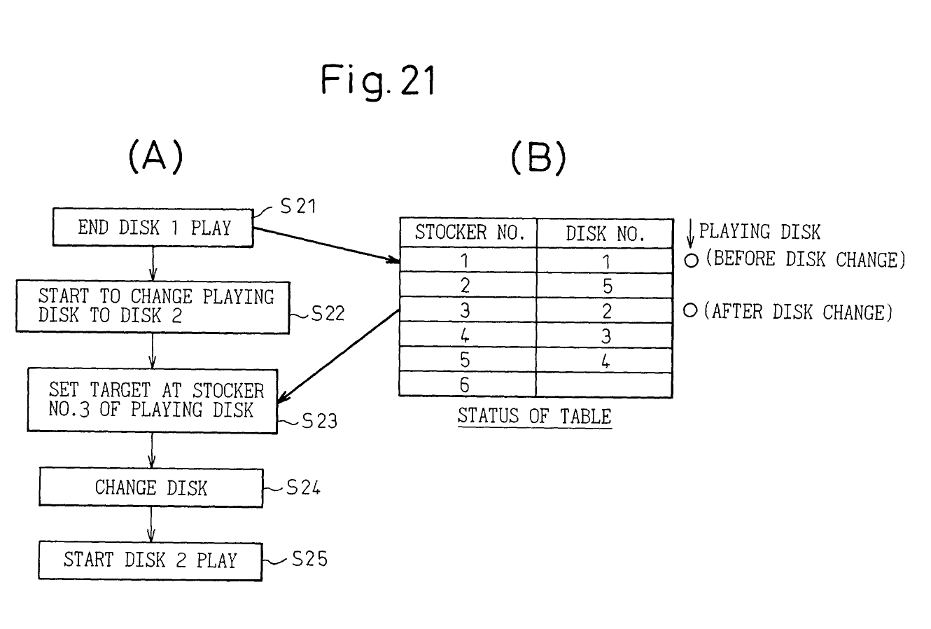

Referring to FIG. 21, the operation for changing the disks will be described.

The disk 1 is being played, and the stocker 1 that has held the disk 1 is in the position opposite to the opening as the target of this operation. Here, when the playback of the disk 1 is finished (Step S21), the changing operation to play the disk 2 consequently is started (Step S22). Then, the stocker 3 that holds the disk 2 that should be played next is set as a new target of the operation (Step S23).

The operation for changing the disks is performed so that the disk 1, that has been played, is contained in the stocker 1 that has been the target of the operation before changing, the disk 2 that is the target of the operation is driven to the playing unit (Step S24), and then the disk 2 is played (Step S25).

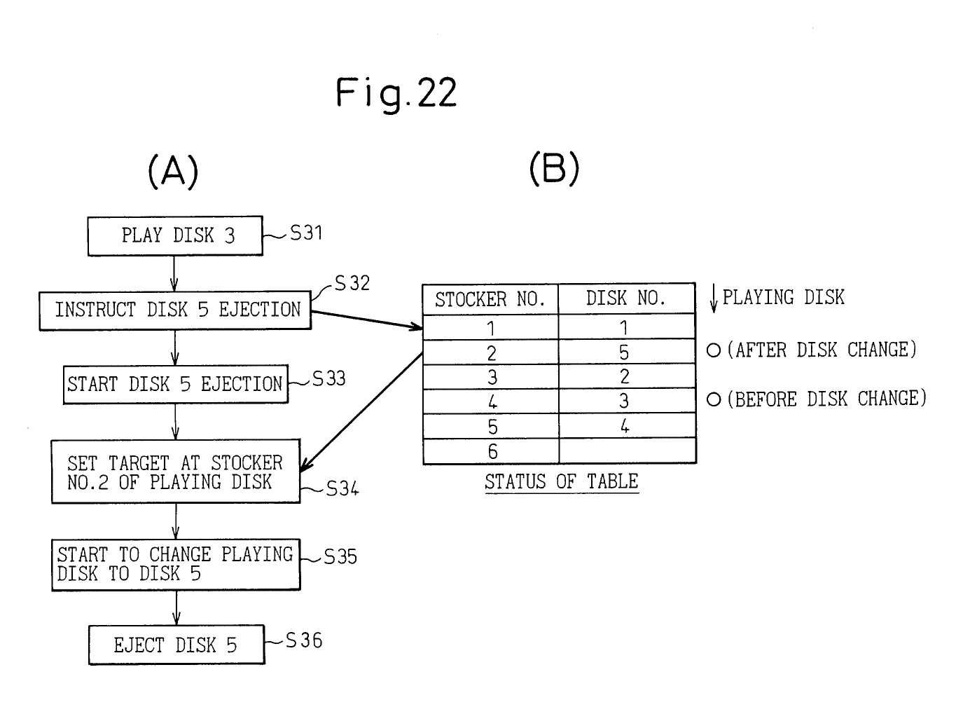

Referring to FIG. 22, the operation for ejecting a disk while another disk is being played will be described.

While the disk 3 is being played (Step S31), when the instruction to eject the disk 5 is received (Step S32), the operation to eject the disk is started (Step S33). The stocker 2 in which the disk 5 is held at present is set as the target of the operation (Step S34). The stocker 2 that is the target of the operation is moved to the position opposite to the opening (Step S35), and the disk 5 is ejected (Step S36).

As described earlier, in the autochanger of the present invention, the order in which the disks are inserted by the user may differ from the order in which the disks are held in the stockers. However, according to the example described with reference to FIG. 19-22, the disk number can be managed by using the simple table.

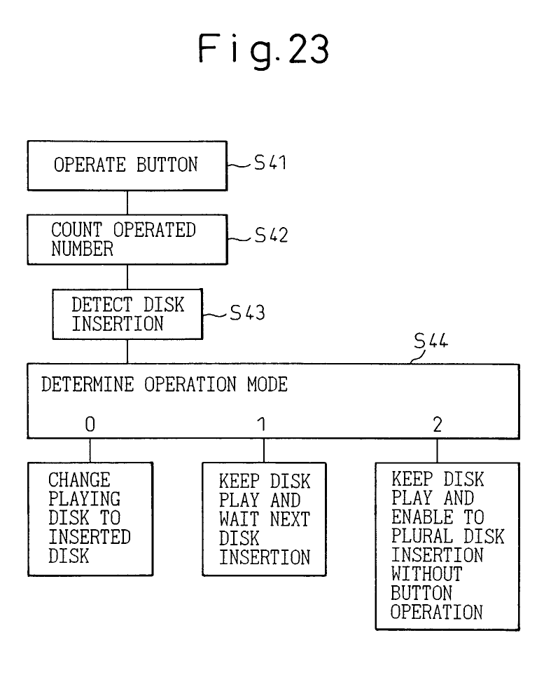

Referring to the flow chart in FIG. 23, the process for determining the operational mode after insertion of the disk will be described.

An operating button (not shown) that is provided on the outside of the apparatus is manipulated (Step S41) to start the shown process. The number of manipulation of the button is counted (Step S42). When the disk 1 is inserted from the opening 7 and the insertion detecting unit 43 (FIG. 2) detected it (Step S434), the process proceeds to the output according to the counted number (Step S44).

If the counted number is 0, the disk is changed so that the inserted disk is played, if the counted number is 1, the inserted disk is not played and the playback of the disk that is being played at present is continued, and if the counted number is 2, a plurality of disks can be inserted without manipulation of the button while the disk is played continuously. Such configuration allows the user to determine whether the playback of the disk that is being played at present is continued or not after the insertion of the disk.

Though the operational mode is determined by the number of manipulations of the operational button in the shown example, it is to be noted that the operational mode can alternatively be determined by the time of manipulation.

Thus, according to the present invention, the disk autochanger having good operability can be obtained while implementing miniaturization of the apparatus.

1. A disk playing apparatus, comprising:
first holding means that can contain a plurality of disks;
second holding means that can contain a plurality of disks;
disk playing means for playing a disk; and
disk transfer means for transferring the disk between said first holding means and said second holding means so that necessary space can be reserved above or below the disk to be played to allow said disk playing means to play the disk.

2. A disk playing apparatus according to claim 1, wherein one disk contained in said first holding means and the other disks contained in said second holding means are overlapped at least partially in a projected area.

3. A disk playing apparatus according to claim 1, wherein, when one disk is played by said disk playing means, the other disks contained in at least one of said first holding means and said second holding means and the disk that is being played are overlapped at least partially in a projected area.

4. A disk playing apparatus according to claim 1, wherein an opening for inserting the disk is provided in proximity to said first holding means and, when the disk is inserted from outside, the disk is contained in said first holding means.

5. A disk playing apparatus comprising an opening for inserting a disk, disk holding means for containing a plurality of disks, and playing means for playing a signal recorded on the disk, wherein a playing operation in said playing means is performed in a state wherein one projected area of the played disk is partially overlapped with the other projected area of the disks contained in said disk holding means, the disk playing apparatus comprising:
first holding means that can contain a predetermined number of disks;
second holding means that can contain one less than said predetermined number of disks;
moving means for moving said first holding means in the direction of stacked disks;
inserting and ejecting means for transferring the disk between said opening and said first holding means,
withdrawing means for transferring the disk between said first holding means and said playing means;
transfer means for transferring the disk between said first holding means and said second holding means; and
controlling means for controlling each of said means,
wherein said controlling means provides control to allow the disk to be inserted from said opening as follows:
containing in said second holding means disks that are located at the side nearer to said second holding means than the disk to be played among disks held in said first holding means;
withdrawing said disk to be played from said first holding means to said playing means; and
associating an empty containing unit in said first holding means that is in the farthest position from said second holding means with said inserting and ejecting means.

6. A disk playing apparatus according to claim 5, further comprising storage means for storing a corresponding relationship between an order of the disks contained in said first holding means and said second holding means in the direction of stacked disks and an order in which the disks have been inserted from said opening.

7. A disk playing apparatus according to claim 5, wherein the disk playing apparatus is configured so that the center line of one disk held in said first holding means is offset to the center line of the other disks held in said second holding means, the outer dimensions of said first holding means are not overlapped with the disks held in said second holding means, and the outer dimensions of said second holding means are not overlapped with the disks held in said second holding means.

8. A disk playing apparatus according to claim 7, further comprising transfer means having a part for engaging with all the center holes of the disks held in said second holding means, the transfer means moving between one stop position corresponding to the center line of the disks held in said first holding means and the other stop position corresponding to the center line of the disks held in said second holding means.

9. A disk playing apparatus according to claim 7, wherein the center line of the disks held in said second holding means substantially coincides with the center position of said playing means during playback.

10. A disk playing apparatus according to claim 5, wherein said moving means is comprised of a first moving means for moving said first holding means between the farthest position from said second holding means and the nearest position to said second holding means, and a second moving means for moving said first holding means in a range of stacked disks the number of which is that can be accommodated in the apparatus.

11. A disk playing apparatus according to claim 10, further comprising shutter means that changes between one state in which said opening is closed and the other state in which said opening is open, wherein said controlling means operates said shutter means as interlocked with said first moving means.

12. A disk playing apparatus according to claim 5, wherein said inserting and ejecting means comprising disk driving means for moving between one stop position in which over wraped with the projected earea the disk held in said first holding means and the other stop position that is not overlapped with the projected area of the disks held in said first holding means.

13. A disk playing apparatus according to claim 12, wherein said controlling means moves said driving means as interlocked with said first moving means.

14. A disk playing apparatus according to claim 5, further comprising a operating button provided on the outside of the apparatus and insertion detecting means for detecting insertion of the disk in said opening, wherein said controlling means determines an operational mode after the disk is inserted based upon the number of manipulations of said operating button until said insertion detecting means detects the insertion of the disk.

15. A disk playing apparatus according to claim 5, further comprising a operating button provided on the outside of the apparatus and insertion detecting means for detecting insertion of the disk from said opening, wherein said controlling means determines an operational mode after the disk is inserted based upon the time of manipulation of said operational button till said insertion detecting means detects the insertion of the disk.

16. A disk playing apparatus comprising disk holding means for containing a plurality of disks, and playing means for playing a signal recorded on the disk, wherein a playing operation in said playing means is performed in a state wherein one projected area of the played disk is overlapped with the other projected area of the disks partially contained in said disk holding means, the disk playing apparatus comprising:
first holding means that can contain a predetermined number of disks;
second holding means that can contain one less than said predetermined number of disks;
moving means for moving said first holding means in the direction of stacked disks;
inserting and ejecting means for transferring the disk between said opening and said first holding means;
transfer means for transferring the disk between said first holding means and said second holding means;
moving means for moving said playing means between one stop position in which the playing operation is performed and the other stop position in which the playing means is not overlapped with a projected area of the disks contained in said first holding means; and
controlling means for controlling each of said means.

17. A disk playing apparatus according to claim 16, wherein said controlling means provides control as follows:
containing in said second holding means disks that are located at the side nearer to said second holding means than the disk to be played among disks held in said first holding means;
withdrawing said disk to be played from said first holding means to said playing means; and
associating an empty containing unit in said first holding means that is in the farthest position from said second holding means with said inserting and ejecting means.
